(19) United States
(12) Patent Application Publication
(10) Pub. No.: US 2009/0166468 A1
(43) Pub. Date: Jul. 2, 2009

(54) METHOD AND APPARATUS FOR SKIN MAPPING OF LIGHTNING DETECTION SYSTEM

(76) Inventors: Dean E. Ryan, Dublin, OH (US); Matthew A. Gessner, Delaware, OH (US); Lawson Wade, Westerville, OH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/965,986

(22) Filed: Dec. 28, 2007

(51) Int. Cl. B64D 45/00; B64D 45/02

(52) U.S. Cl. 244/1 A; 244/1 R

(57) ABSTRACT

A lightning strike to an aircraft causes problems in existing aircraft equipment. To offset the problem, weather equipment can be used, but the weather equipment is prone to noise interference with existing aircraft equipment. By effectively positioning the weather equipment, the present invention solves the noise interference problem. In particular, the process detects an environment event, using weather equipment, on the subject aircraft. Next, the system identifies an origination point of noise, resulting from the detected environment event, in internal aircraft equipment. After identifying the origination point of the noise, the system makes a measurement to determine if the noise is interfering with a signal of the internal aircraft equipment. If interference exists, an operator cancels the noise and adjusts the location of the weather equipment in an external surface of the subject aircraft in such a manner as to provide an interference free environment for the internal aircraft equipment.

### RELATED APPLICATIONS

This application is related to U.S. application Ser. No. 11/488,792, entitled “Method and Apparatus for Detecting and Processing Lightning”, filed on Jul. 19, 2006, which claims the benefit of the filing date of co-pending provisional application Ser. No. 60/700,334, filed on Jul. 19, 2005. The entire teachings of the above applications are incorporated herein by reference.

### BACKGROUND OF THE INVENTION

A lightning detector is a device that detects lightning produced by thunderstorms or other static discharge. Generally there are three types of lightning detectors: ground-based systems using multiple antennas, mobile detectors using a direction and a sense antenna in the same location (often aboard an aircraft), and space-based systems. Ground-based systems use triangulation from multiple locations to determine distance to detected lightning, while mobile detectors estimate distance using signal frequency and attenuation. In contrast, a mobile detector calculates the direction and severity of lightning from the current location using radio direction-finding techniques together with an analysis of the characteristic frequencies emitted by lightning. Space-based lighting detectors, on artificial satellites, locate range, bearing, and intensities by direct observation.

In smaller aircraft, such as general aviation, lightning detectors (often referred to as sferics short for Radio Atmospherics) are employed because they are inexpensive and lightweight. These benefits of lightning detectors are attractive to owners of small/light aircraft (particularly of single-engine aircraft, where the aircraft nose is not available for installation of a radome).

Employing a lightning detector in an aircraft introduces new equipment and associated noise, to an aircraft that already has a vast amount of existing equipment. Modern passenger aircraft, for example, have miles of wires and dozens of computers/other instruments controlling components, such as engines or passengers' music headsets. These computers, however, are susceptible to upset from power surges. Thus, a lightning protection engineer should assure no damaging surges or transients can be induced into the sensitive computer/equipment inside of the aircraft. For example, lightning traveling on the exterior skin of an aircraft has the potential to induce transients into wires or equipment beneath the skin resulting in damage to existing aircraft equipment.

Transients are typically called lightning indirect effects and cause problems in cables and equipment without careful shielding, grounding, and/or the application of surge suppression devices. Thus, each component, computer, and/or equipment which is important to the safe flight and landing of an aircraft is verified by the manufacturers to be protected against lightning in accordance with regulations of the Federal Aviation Administration (FAA) or a similar regulatory agency/authority in the country of the aircraft's origin. Therefore, the protection from lightning indirect effects (e.g., noise) of aircraft equipment is desirable.

### SUMMARY OF THE INVENTION

The present invention addresses the concerns of the prior art. In particular, the present invention provides a system and method for skin mapping a lightning detector (or weather) system on aircraft. In an embodiment, a method or corresponding apparatus positions weather equipment in an aircraft in a manner that provides an interference free (or minimized interference) environment. The invention system detects an environment event, using weather equipment, in the aircraft during flight. Next, the system identifies an origination point of noise resulting from the environment event, in internal aircraft equipment. After identifying the origination point of the noise, the invention system quantitatively determines (i.e., measures) whether the noise is interfering with a signal of the internal aircraft equipment. If interference exists, an operator adjusts the location of the weather equipment in an external location of the aircraft in such a manner as to provide an interference free environment.

In an embodiment of the invention, a method or corresponding apparatus provides an installer with information to install weather equipment. The invention system 1) simulates an in-flight environment event of an aircraft resulting in noise in internal aircraft equipment; 2) identifies an origination point of the noise, in the internal aircraft equipment; and 3) determines levels (measurements) of interference with a signal (e.g., frequency band) of the internal aircraft equipment in a manner that determines a corresponding interference-free location of weather equipment. After determining an ideal (interference-free or minimized interference producing) location for the weather equipment, an installer installs the weather equipment accordingly and provides an interference free environment.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram of an example node connected to aircraft equipment to determine a position to mount weather equipment according to embodiments of the present invention;

FIG. 2 is a schematic illustration of the example node's display presenting data and corresponding graphs according to principles of the present invention;

FIG. 3 shows an example graphical output for use by an operator according to embodiments of the present invention;

FIG. 4 is a schematic view of an example aircraft with weather equipment positioned on the skin of an aircraft in accordance with an embodiment of the present invention; and

FIG. 5 is an flow diagram for positioning weather equipment on an aircraft skin in accordance with an embodiment of the present invention.

### DETAILED DESCRIPTION OF THE INVENTION

A description of example embodiments of the invention follows.

Aircraft Lightning Detection systems (including lightning detectors and weather equipment generally) are designed to help protect each of the equipment, computers, instruments and the like in an aircraft. A lightning detector, for example, assures engineers that damaging surges do not reach aircraft equipment. Lightning detectors, however, can present interference with existing aircraft equipment. Employing embodiments of the present invention protect aircraft equipment, cables, and circuits using software in a node (e.g., a computer) that graphical identifies the levels of interfering noise from the lightning detection system (e.g., weather equipment).

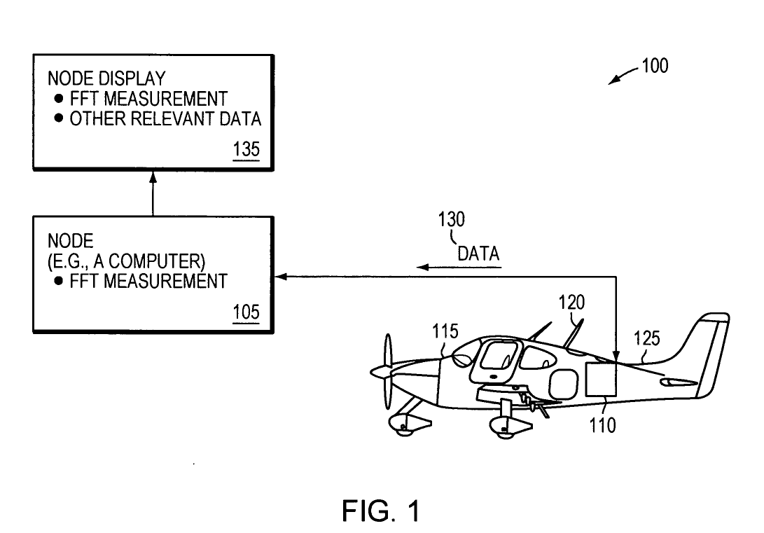

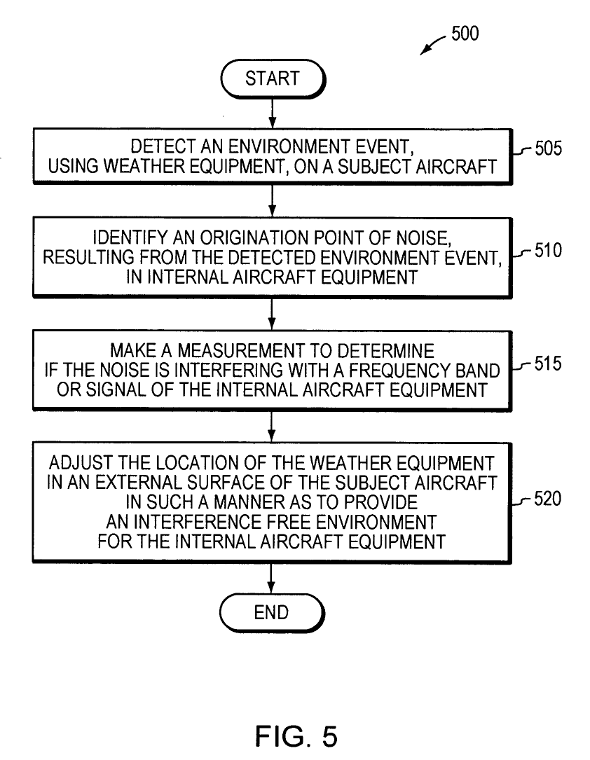

FIG. 1 shows a diagram of one embodiment 100 of the present invention. A node 105 (e.g., a computer) is connected or otherwise coupled to aircraft equipment 110 in an aircraft 115. The node 105 determines a position (external location) to mount the weather equipment 120 according to principles of the present invention. In an embodiment, the node 105 connects to internal and/or external aircraft equipment 110 via a traditional connection (e.g., RS-323, Ethernet, or the like). Next, an operator/user of invention system 100 affixes weather equipment 120, such as a lighting detector/rod (either by tape or suction) to the skin 125 of the aircraft 115. In this example, the node 105 provides to the operator an indication of location for the weather equipment 120 based on where a minimal amount or no noise interference with other aircraft equipment 110 is found. An example of determined ideal (low or no interference producing) placement of the weather equipment 120 is shown in FIG. 5. It is useful to note that the weather equipment 120 may include a radome of the aircraft. It should be understood that the weather equipment 120 can be located in any portion of the aircraft.

For determining ideal placement of the weather equipment 120, the node 105 simulates environments that the aircraft may be exposed to and resulting noise/interference generates measurements displayed to the operator. For example, node 105 indicates to the operator if noise exists in the skin 125 of the aircraft 115 and the levels of noise per location on the skin before affixing the weather equipment 120. Using these measurements, the operator identifies where to affix the weather equipment 120 on the skin 125 of the aircraft 115.

One example measurement that node 105 makes employs a Fast Fourier Transform (FFT). The node 105 makes the FFT measurement by (i) applying a Fourier analysis and transform to data 130 from the aircraft equipment 110, and a function describing or approximating data 130, and (ii) identifying therefrom a spectral content of noise in a non-filtered signal within the aircraft 115. After identifying the spectral content of noise, the node 105 displays the resulting noise dependency/relationship data in a graphical output to the operator/user in a node display 135.

Based on the frequency in a non-filtered signal shown in the node display 135, the operator notes what existing equipment 110 in the aircraft 115 is creating the noise. In turn, the operator chooses the placement of the weather equipment 120 or the calibration of the weather equipment 120 on the aircraft skin 125 according to noted noise generating equipment of the aircraft 115. It should be understood that the placement of the weather equipment 120 can also be indicated by node 105, a software, hardware, or firmware program. In other embodiments, the operator or a software program can cancel the noise, instead of or in addition to adjusting/calibrating the weather equipment 120 by using noise cancellation techniques employed in the art.

In an embodiment, the node 105 overcomes noise interference between the existing aircraft equipment 110 and the weather equipment 120 by detecting the signature of lighting over low frequency while cancelling the resulting noise in the low frequency band. To overcome the problem of noise in the low frequency, embodiments of the present invention can use a wide band receiver in node 105 (as described below). In turn, the wide band receiver detects a broad spectrum of static electric discharge and enables various data to be obtained. Using the obtained data, the node 105 displays detailed information about weather/surrounding conditions and resulting a noise interference as opposed to displays of traditional systems that merely describe conditions as good or bad. It should be understood that different configurations of the wide band receiver and node 105 are suitable including a configuration tier where the wide band receiver is separate from node 105. The above is for purposes of illustration and not limitation. example.

As discussed above, the node 105 makes an FFT measurement and provides a graphical output of a detected broad spectrum of static electric discharge. The graphical output presents a spectral content of noise resulting within the aircraft 115. A FFT is an efficient algorithm to compute the Discrete Fourier Transform (DFT) and its inverse. FFTs are of useful for a wide variety of applications, from digital signal processing and solving partial differential equations to algorithms for quickly multiplying large integers. An example formula is defined as:

$${X}_{k} = {\sum }_{n = 0}^{N - 1} {x}_{n} {e}^{- \frac{2 πi}{N} nk}$$

$$k = 0 , … , N - 1.$$

where x₀, x_{N-1} are complex numbers. Evaluating the formula sums directly would take O(N²) arithmetical operations. An FFT is an algorithm to compute the same result in only O(N log N) operations. In general, such algorithms depend upon the factorization of N, but (contrary to popular misconception) there are FFTs with O(N log N) complexity for all N, even for prime N.

Many FFT algorithms only depend on the fact that

$${e}^{- \frac{2 πi}{N}}$$

is a primitive root of unity, and thus can be applied to analogous transforms over any finite field, such as number-theoretic transforms. Since the inverse DFT is the same as the DFT, but with the opposite sign in the exponent and a 1/N factor, any FFT algorithm can easily be adapted for it as well. Moreover, inclusion of cosine waves as well as sine waves takes care of phase, and the letters represent the amplitude of each component. This result is easily translated into a bar graph with one bar per component. It should be understood that a three dimensional graph can provide the amplitudes of a sound change or noise interference of various components more effectively. It should also be noted that the FFT measurements can be applied to aircraft that include substantially similar or the same aircraft equipment 110 because unwanted noise originates from the same equipment source.

In an embodiment of the present invention, node 105 uses a non-filtered signal, if useful, for a more accurate detection of unwanted noise. A process, for example, utilizes the signal in filtered form and determines whether to use the initial non-filtered signal. That is, that process studies the filtered signal and based on the width and saturation level of the signal determines if the filtered signal is useable (e.g., unsaturated) to ensure accuracy. If the filtered signal is saturated, the process uses the original non-filtered signal for increased accuracy of noise measurement. A saturation detector determines whether the filtered signal is saturated as described in greater detail in U.S. patent application Ser. No. 11/963,184 by assignee. A filtered signal that is saturated is generally understood as a received signal with a power level that exceeds the dynamic range of the receiver. For such a level, any increase in the power level causes no appreciable change in the output of the receiver.

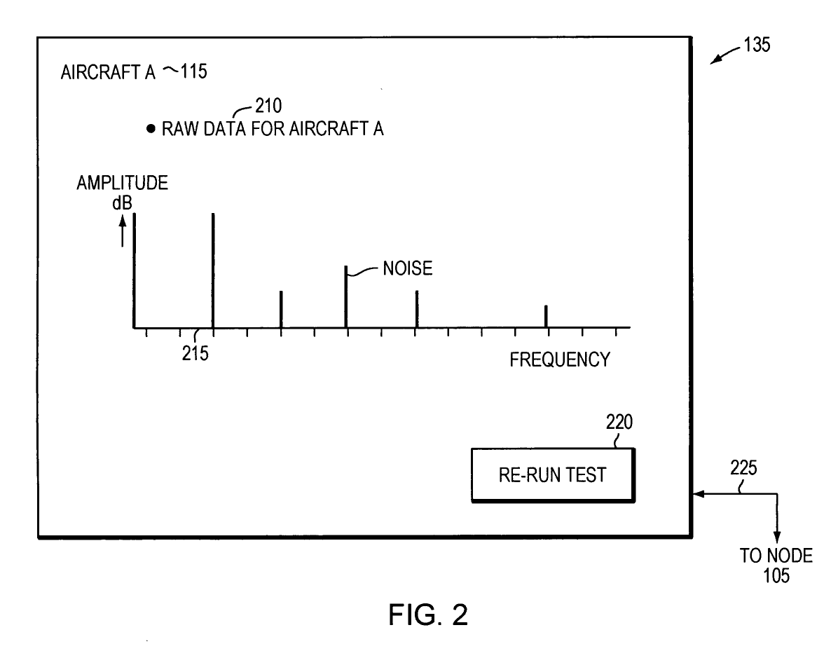

FIG. 2 shows an example node display 135 of node 105 presenting a graphical output 215 to an operator according to embodiments of the present invention. The node display 135 provides indications of noise and other information for aircraft A 115 to a user. In particular, the node display 135 connects to node 105 via a communications path 225 for obtaining data 130 and any corresponding FFT measurements. Using the data 130 and measurements, the node display 135 displays raw data 210 for aircraft A 115. The raw data 210 includes noise data for aircraft equipment, such as aircraft equipment 110 of FIG. 1, and non-filtered signal data for aircraft A 115. An operator or a software program studies the raw data 210 (e.g., non-filtered signal) to determine the noise source.

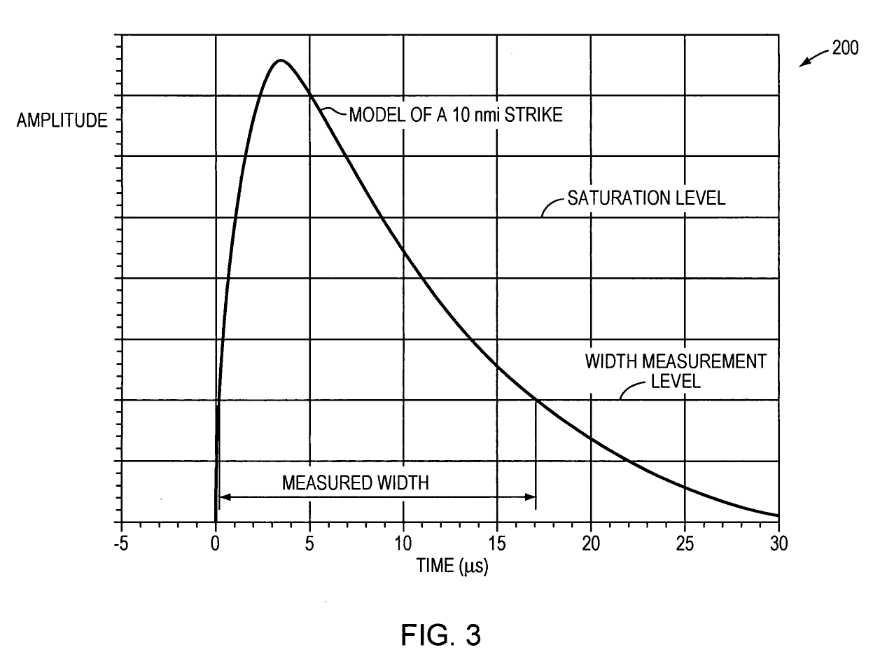

The graphical output 215 is in some embodiments a bar graph that displays the noise for aircraft A 115 to a user in terms of decibel (e.g., amplitude) and frequency for the aircraft equipment 110. The bar graph allows the operator to effectively identify the spectral content of noise and determine what existing aircraft equipment 110 in the aircraft A 115 is creating the noise. After determining the aircraft equipment 110 creating noise, the operator re-positions or positions for the first time the subject weather equipment 120. If the operator changes the location of the weather equipment 120, the operator can generate an updated graphical output 215 by pressing the re-run test button 220. By pressing the re-run test button 220, the node display 135/node 105 presents the operator with new raw data 210 and corresponding graphs 215 and 200 (FIG. 3). In this way, the node 105 identifies the spectral content of noise with the new configuration. An example additional corresponding graph 200 is shown in FIG. 3.

Principles of the present invention provide a simulation of a lightning strike used by the node display 135 to generate a graphical output, such as the example graphical output 200 shown in FIG. 3. In particular, FIG. 3 shows an example graphical output 200 for use by an operator according to embodiments of the present invention. In an embodiment, the node 105 creates the graph 200 and 215 using a three-channel wide band receiver with multiple inputs to an A-D converter. Example inputs include a V loop channel ADC (receiving one of the loop antenna inputs to the wide band receiver), a sense channel ADC (receiving the electric field sensor input to the wide band receiver) and a H channel ADC (receiving the other magnetic loop input). In an embodiment, each channel includes a four-sample delay FIFO, adder and sign changer to produce in the registers a four-sample sum. The four-sample sum is shifted right two bits to generate a running average of the most recent four samples. The output is a sequence of samples representing a four-sample running average of the sense channel. Similar outputs represent a running average of the V loop and H loop channels, respectively. The H and the V channels also include a one-sample delay adder and sign changer. The output represents the slope of the V channel and H channel, respectively. This is simply the difference between the most recent running average and the immediately prior running average. Finally, the outputs of the shifters are provided to the comparator to select the maximum loop channel called Max Loop.

As a result, multiple outputs are generated from the ADC three inputs. These outputs include the V channel slope, the V channel running average, the sense channel (the S channel) running average, max loop, the running average of the H channel and the slope of the H channel. Using these outputs, embodiments of the present invention create a graph, such as graphical output 215 of FIG. 2 or 200 FIG. 3.

A logic of the signal processor complex in node 105 responds to the inputs provided by the ADC, a set of flags, variables and constants and the values in several programmable registers. The flags, variables and constants are defined as follows:

H=H loop average.

V=V loop average.

S=Sense channel average.

Max Loop=Greater of H or V, (Unsigned comparison)

Loop=The loop channel that is to be used to detect the zero crossing. When the Which Valid flag is not set, Loop is the same as Max Loop. When the Which Valid flag is set, Loop is the channel that the Which flag points at.

H Slope=H−Hprev.

V Slope=V−Vprev.;

Hprev=The value of H during the previous sample, H[n−1].

Vprev=The value of V during the previous sample, V[n−1]

Last Loop Sign=Sign of Loop during the previous sample.

Delayed S=If S[N] is the current sample then Delayed S is S[N−6]. In other words, the S sample is 6 samples old.

Which flag=When a strike is active, this indicates which loop channel caused the highest peak. This is latched during the first peak on the first sample that does not cause a new highest peak.

Which Valid flag=Set when the Which flag has been set.

First Peak=This is the H, V, and S amplitudes at the peak of First Peak. This may not be the literal first peak of the waveform if the literal first peak is more than 25% below the amplitude of a subsequent peak. Initial peaks that are more than 25% below the amplitude of a subsequent peak are considered leader currents.

Overshoot Peak=The H, V, and S amplitudes of the highest amplitude sample detected during the overshoot. The overshoot begins following the first zero crossing after the first peak, and continues until the second zero crossing

This Peak=The H, V, and S amplitudes of the highest amplitude sample detected during the waveform peak that is currently being received. Later, a decision will be made about whether to save This Peak as the First Peak or Overshoot Peak.

Max Peak=This is the H, V, and S amplitude of the sample that caused the highest Loop amplitude during the strike.

Duration=Number of samples comprising the strike, includes the first sample to exceed MTL and all following samples until the end of the strike. (See FIG. 3.)

Recovery=Count of number of samples below ZTL as illustrated in FIG. 3. This is used to determine if the strike is finished.

Peak Time=Number of samples that loop has been above ZTL.

Strike in Progress=Flag that indicates that the system is currently in the process of receiving a strike.

Peak in Progress=Flag that indicates that the system is in the process of receiving a peak of the waveform.

CW Error flag=Flag used to report conditions that may impair strike detector performance. This flag should be made available for the software (of the programmable processor) to read. This flag can only be cleared by the software.

Microphone flag=Indicates that the microphone was active at some time during reception of the strike. A latched copy of this flag should be made available for the software to read. The copy should not be cleared until specifically cleared by the software.

SenseZeroCross=Flag that indicates whether the sense channel has fallen back below ZTL.

LoopZeroCross=Flag that indicates whether Max Loop has fallen back to ZTL.

FirstZeroCross=Non-zero after the first zero crossing.

ZeroCrossingCount=The count of the number of zero crossings detected.

ZeroCrossDelay=The number of samples between the time that the Sense channel and Max Loop fall below ZTL. This is an unsigned value and it does not depend upon one or the other falling below ZTL first.

Peaks Before=The number of peaks before First Peak that were greater than the largest peak before it, and which were less than four times the amplitude of the largest peak preceding it. Note that Peaks Before is reset whenever a peak is found that is four times or more the amplitude of the highest peak before it.

Enable S Latch=This is a counter that counts down the number of samples following an update of This Max Peak that was checked in the Delayed S for a maximum peak. This compensates for the phase mismatch between the loops channels and the S channel.

The values which are obtained from programmable registers in the processor complex 105 are defined as follows:

Recovery Period=The number of samples below MTL required for a strike to be declared complete. FIG. 3 is illustrative.

CW Duration=Longest strike duration that dos not cause the noise error flag to be set.

Saturation Level=At or about this level a loop channel is said to be saturated.

MTL=Minimum Trigger Level Strike processing will begin if Max Loop exceeds MTL (FIG. 3). This level should be set low enough to detect smaller peaks that may precede the primary peak, since such smaller peaks may invalidate the strike.

RTL=Report Trigger Level. Once a strike is finished, it will not be reported unless the First Peak Max amplitude that was latched during this strike is greater than RTL.

WTL (Width Trigger Level)=level where pulse width is measured (see FIG. 3).

ZTL (Zero Trigger Level)=When Max Loop is below ZTL the Peak Time counter is cleared.

Finally, definitions of a number of peak related variables are defined as follows:

H=The maximum value of H during the peak

V=The maximum value of V during the peak.

S=The maximum value of S during the peak.

Max=The maximum amplitude seen on either the H or V channel during the peak.

H Width=The number of samples that H was above WTL.

V Width=The number of samples that V was above WTL.

H Saturation Flag=Did H saturate during this peak?

V Saturation Flag=Did V saturate during this peak?

Hsat Width=The number of samples that the H channel was saturated.

Vsat Width=The number of samples that the V channel was saturated.

Rise Time=Number of samples above MTL up to and including the highest amplitude sample.

Fall Time=Number of samples following the highest amplitude sample up to the zero crossing. This count should include the first sample below zero. If a zero crossing is not detected, then this will be the number of samples from the peak to the end of the strike.

Up H=The H amplitude of the sample immediately preceding the highest amplitude sample.

Up V=The V amplitude of the sample immediately preceding the highest amplitude sample.

Up S=The S amplitude of the sample immediately preceding the highest amplitude sample.

Max H Slope=The maximum value of H Slope detected during the peak.

Max V Slope=The maximum value of V Slope detected during the peak.

One function of signal processor complex 105 is to filter out invalid strikes from the valid signals using the six inputs from the ADC, as well as the values in the programmable registers.

For the strikes which are not filtered out, the signal processor 105 also determines a plurality of parameters to characterize the respective waveforms. As will be described these parameters are passed on for further processing.

For each apparently valid strike the signal processor complex 105 generates the following data for further processing:

Time tag: with a resolution measured in microseconds.

First Peak—H amplitude and up amplitude.

First Peak—V amplitude and up amplitude.

First Peak—S amplitude and Max Loop.

Overshoot Peak—H amplitude and Max Slope of First Peak.

Overshoot Peak—V amplitude and Max Slope of First Peak.

Overshoot Peak—S amplitude and Max Loop amplitude.

Max Peak—H amplitude and MTL.

Max Peak—V amplitude.

Max Peak—S amplitude and Max Loop.

First Peak—H width (# of saturated samples) and V width (# of saturated samples).

First Peak—H saturation flag, V saturation flag, H width (# of samples >WTL), V width (# of samples >WTL).

Timer Data—First Peak rise time (from ZTL to peak), First Peak fall time, total strike duration.

Status—Valid flag, H CW Freq. fail flag, Microphone flag, V CW Freq. fail flag, CW error flag, Peaks before count (First Peak), zero crossing count (First Peak), Zero crossing delay (# of samples between S and loop going below ZTL).

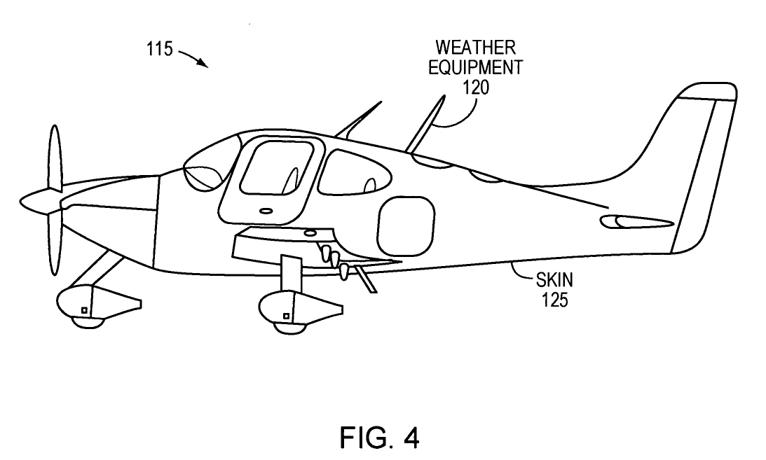

Using the above data and a graphical representation, such as FIG. 3, the operator can identify the spectral content of noise signal and position weather equipment 120 in view of the same. In some embodiments, however, the noise signal is saturated because of the strike. If the noise signal is saturated, the node 105, having a receiver as described in U.S. patent application Ser. No. 11/963,184 by assignee, uses a non-filtered signal for positioning of the weather equipment 120 or aircraft skin 125 as shown in FIGS. 1 and 4.

FIG. 4 shows an example aircraft 115 with weather equipment 120 positioned on the skin 125 of the aircraft 115 in accordance with an embodiment of the present invention. In particular, the operator or installer, using the graphical output, such as presented in FIG. 2, positions the weather equipment 120 on the skin 125 of the aircraft 115. Once the weather equipment 120 is positioned, the operator can re-run the calculations as described above to determine if noise interference with the existing aircraft equipment 110 exists. If no noise interference exists, the weather equipment 120 is permanently affixed otherwise the operator continues the process. Once the position of the weather equipment 120 is finalized, the operator can position the weather equipment 120 on additional aircraft having substantially the same equipment 110 and configuration. That is, aircraft having the same equipment 110 as aircraft 115 would have the same noise interference and as such new calculations are not required. An operator may simply place the weather equipment 120 on the additional aircraft as a relatively same skin location/position. It should be understood that although new calculations are not required, the operator may choose to do so.

FIG. 5 shows an flow diagram for positioning weather equipment on an aircraft skin in accordance with an embodiment of the present invention. After beginning, a process 500 detects, in step 505 an environment event (simulated or otherwise), using weather equipment 120, on a subject aircraft. At step 510, the process 500 determines and identifies noise in internal aircraft equipment 110 resulting from the environment event and an origination point of the noise. After identifying the origination point, the process 500 at step 515 makes a measurement to determine if the noise is interfering with a frequency band or signal of the internal aircraft equipment 110. Next, the process 500 at step 520 adjusts the location of the weather equipment 120 in an external surface of the subject aircraft in such a manner as to provide an interference free environment for the internal aircraft equipment. It is useful to note that in some embodiments, if interference exists, the process 500 may cancel the noise (not shown). It should be understood that in an embodiment, the process 500 can also readjust the weather equipment 120 instead of cancelling the noise.

While this invention has been particularly shown and described with references to example embodiments thereof, it will be understood by those skilled in the art that various changes in form and details may be made therein without departing from the scope of the invention encompassed by the appended claims.

What is claimed is:

1. A method for positioning weather equipment on an aircraft, comprising:
detecting an environment event using weather equipment on a subject aircraft;
identifying an origination point of noise, resulting from the detected environment event, in internal aircraft equipment;
making a measurement to determine if the noise is interfering with a signal of the internal aircraft equipment; and
adjusting location of the weather equipment on an external surface of the subject aircraft in such a manner as to provide an interference free environment for the internal aircraft equipment.

2. A method as is claimed in claim 1 wherein the environment event is a static electric discharge.

3. A method as is claimed in claim 1 further comprising the step of cancelling the noise including rejecting surge currents in the noise interference measurement made.

4. A method as is claimed in claim 1 wherein the noise interference measurement is a Fast Fourier Transform calculating a complete spectral analysis.

5. A method as is claimed in claim 1 wherein the step of identifying an origination point of noise further comprises the steps of:
making a Fast Fourier Transform measurement; and
displaying the Fast Fourier Transform measurement to an operator.

6. A method as is claimed in claim 5 wherein the operator is an installer of the weather equipment.

7. A method as is claimed in claim 5 further comprising the step of:
the operator, calibrating the weather equipment based on the Fast Fourier Transform measurement.

8. A method as is claimed in claim 1 wherein the weather equipment is in a radome of the aircraft.

9. A method as is claimed in claim 1 wherein the weather equipment utilizes electrically conductive wires.

10. An apparatus for positioning weather equipment, comprising:
weather equipment configured to detect an environment event in a subject aircraft;
a node to identify an origination point of noise, in internal aircraft equipment, that results from the detected environment event;
the node configured to determine if the noise interferes with a signal of the internal aircraft equipment by making a measurement; and
the node further configured to determine the location of the weather equipment on an external surface of the aircraft in such a manner as to provide a noise free environment for the internal aircraft equipment.

11. An apparatus as is claimed in claim 10 wherein the environment event is a static electric discharge.

12. An apparatus as is claimed in claim 10 further comprising the node configured to reject surge currents in the noise interference measurement made.

13. An apparatus as is claimed in claim 10 wherein the measurement is a Fast Fourier Transform to calculate a complete spectral analysis.

14. An apparatus as is claimed in claim 10 wherein node identifies the origination point using a Fast Fourier Transform measurement and displays the Fast Fourier Transform measurement to the operator.

15. An apparatus as is claimed in claim 14 wherein the operator installs the weather equipment.

16. An apparatus as is claimed in claim 14 wherein the operator calibrates the weather equipment based on the Fast Fourier Transform measurement.

17. An apparatus as is claimed in claim 10 wherein the weather equipment is in a radome of the aircraft.

18. An apparatus as is claimed in claim 10 wherein the weather equipment utilizes electrically conductive wires.

19. A method for installing weather equipment, comprising:
simulating an environment event in a subject aircraft;
identifying an origination point of noise, resulting from the simulated environment event, in the internal aircraft equipment;
making a measurement of interference with a signal of the internal aircraft equipment to determine a location of weather equipment without interference; and
installing the location of the weather equipment on an external surface of the subject aircraft in such a manner as to provide an interference free environment for the internal aircraft equipment.

20. A method as is claimed in claim 19 wherein an installer installs the weather equipment on a plurality of aircraft having substantially the same internal aircraft equipment.
